(19) United States
(12) Patent Application Publication
(10) Pub. No.: US 2024/0278434 A1
(43) Pub. Date: Aug. 22, 2024

(54) Robotic Systems and Methods Used with Installation of Component Parts

(71) Applicant: ABB Schweiz AG, Baden (CH)

(72) Inventors: Yinwei Zhang, Raleigh, NC (US); Qilin Zhang, Chicago, IL (US); Biao Zhang, Apex, NC (US); Jorge Vidal-Ribas, Esplugues de Llobregat (ES)

(73) Assignee: ABB Schweiz AG, Baden (CH)

(21) Appl. No.: 18/570,156

(22) PCT Filed: Jun. 17, 2021
(86) PCT No.: PCT/US21/37792

§ 371 Date: Dec. 14, 2023

(51) Int. Cl. B25J 9/16; B25J 11/00

(52) U.S. Cl. CPC B25J 9/1697; B25J 9/1664; B25J 11/0075

(57) ABSTRACT

A robotic system for use in installing final trim and assembly part includes an auto-labeling system that combines images of a primary component, such as a vehicle, with those of computer based model, where feature based object tracking methods are used to compare the two. In some forms a camera can be mounted to a moveable robot, while in other the camera can be fixed in position relative to the robot. An artificial marker can be used in some forms. Robot movement tracking can also be used. A runtime operation can utilize a deep learning network to augment feature-based object tracking to aid in initializing a pose of the vehicle as well as an aid in restoring tracking if lost.

### TECHNICAL FIELD

The present disclosure generally relates to robotic installation of component parts, and more particularly, but not exclusively, to final trim and assembly robotic operations.

### BACKGROUND

A variety of operations can be performed during the final trim and assembly (FTA) stage of automotive assembly, including, for example, door assembly, cockpit assembly, and seat assembly, among other types of assemblies. Yet, for a variety of reasons, only a relatively small number of FTA tasks are typically automated. For example, often during the FTA stage, while an operator is performing an FTA operation, the vehicle(s) undergoing FTA is/are being transported on a line(s) that is/are moving the vehicle(s) in a relatively continuous manner. Yet such continuous motions of the vehicle(s) can cause or create certain irregularities with respect to at least the movement and/or position of the vehicle(s), and/or the portions of the vehicle(s) that are involved in the FTA. Moreover, such motion can cause the vehicle to be subjected to movement irregularities, vibrations, and balancing issues during FTA, which can prevent, or be adverse to, the ability to accurately track a particular part, portion, or area of the vehicle directly involved in the FTA. Traditionally, three-dimensional model-based computer vision matching algorithms require subtle adjustment of initial values and frequently loses tracking due to challenges such as varying lighting conditions, parts color changes, and other interferences mentioned above. Accordingly, such variances and concerns regarding repeatability can often hinder the use of robot motion control in FTA operations.

Accordingly, although various robot control systems are available currently in the marketplace, further improvements are possible to provide a system and means to calibrate and tune the robot control system to accommodate such movement irregularities.

### SUMMARY

One embodiment of the present disclosure is a unique labeling system for use in neural network training. Other embodiments include apparatuses, systems, devices, hardware, methods, and combinations for robustly tracking objects during final trim and assembly operations using a trained neural network. Further embodiments, forms, features, aspects, benefits, and advantages of the present application shall become apparent from the description and figures provided herewith.

### BRIEF DESCRIPTION OF THE FIGURES

FIG. 1 illustrates a schematic representation of at least a portion of an exemplary robotic system according to an illustrated embodiment of the present application.

FIG. 2 illustrates a schematic representation of an exemplary robot station through which vehicles are moved through by an automated or automatic guided vehicle (AGC), and which includes a robot that is mounted to a robot base that is moveable along, or by, the track.

FIG. 3 illustrates sensor inputs that may be used to control movement of a robot.

FIG. 4 illustrates an assembly line with a moving assembly base and a moving robot base.

FIG. 5 illustrates a flow chart of one embodiment of an unsupervised auto-labeling system.

FIG. 6 illustrates a flow chart of one embodiment of an unsupervised auto-labeling system.

FIG. 7 illustrates an embodiment of an artificial marker used in one embodiment of an unsupervised auto-labeling system.

FIG. 8 illustrates a flow chart of one embodiment of an unsupervised auto-labeling system.

FIG. 9 illustrates one embodiment of a runtime process by which a feature based object tracker is augmented by a neural network.

### DETAILED DESCRIPTION OF THE ILLUSTRATIVE EMBODIMENTS

For the purposes of promoting an understanding of the principles of the invention, reference will now be made to the embodiments illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Certain terminology is used in the foregoing description for convenience and is not intended to be limiting. Words such as “upper,” “lower,” “top,” “bottom,” “first,” and “second” designate directions in the drawings to which reference is made. This terminology includes the words specifically noted above, derivatives thereof, and words of similar import. Additionally, the words “a” and “one” are defined as including one or more of the referenced item unless specifically noted. The phrase “at least one of” followed by a list of two or more items, such as “A, B or C,” means any individual one of A, B or C, as well as any combination thereof.

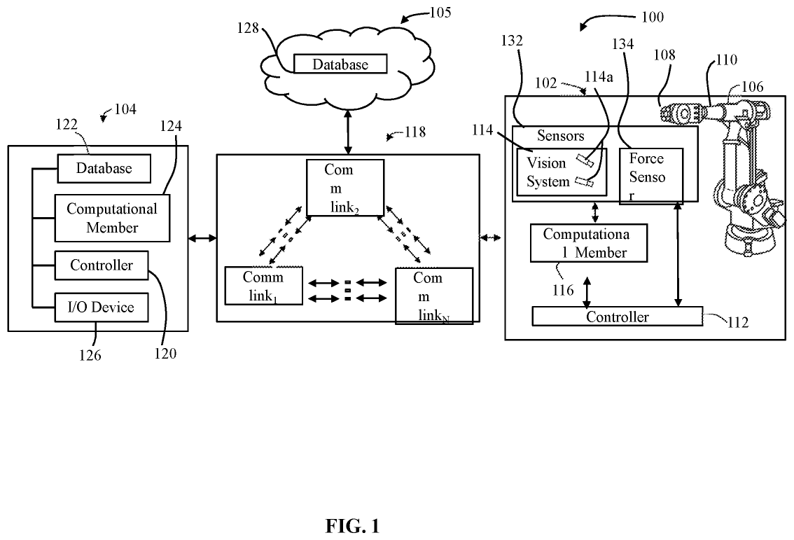

FIG. 1 illustrates at least a portion of an exemplary robotic system 100 that includes at least one robot station 102 that is communicatively coupled to at least one management system 104, such as, for example, via a communication network or link 118. The management system 104 can be local or remote relative to the robot station 102. Further, according to certain embodiments, the management system 104 can be cloud based. Further, according to certain embodiments, the robot station 102 can also include, or be in operable communication with, one or more supplemental database systems 105 via the communication network or link 118. The supplemental database system(s) 105 can have a variety of different configurations. For example, according to the illustrated embodiment, the supplemental database system(s) 105 can be, but is not limited to, a cloud based database.

According to certain embodiments, the robot station 102 includes one or more robots 106 having one or more degrees of freedom. For example, according to certain embodiments, the robot 106 can have, for example, six degrees of freedom. According to certain embodiments, an end effector 108 can be coupled or mounted to the robot 106. The end effector 108 can be a tool, part, and/or component that is mounted to a wrist or arm 110 of the robot 106. Further, at least portions of the wrist or arm 110 and/or the end effector 108 can be moveable relative to other portions of the robot 106 via operation of the robot 106 and/or the end effector 108, such for, example, by an operator of the management system 104 and/or by programming that is executed to operate the robot 106.

The robot 106 can be operative to position and/or orient the end effector 108 at locations within the reach of a work envelope or workspace of the robot 106, which can accommodate the robot 106 in utilizing the end effector 108 to perform work, including, for example, grasp and hold one or more components, parts, packages, apparatuses, assemblies, or products, among other items (collectively referred to herein as “components”). A variety of different types of end effectors 108 can be utilized by the robot 106, including, for example, a tool that can grab, grasp, or otherwise selectively hold and release a component that is utilized in a final trim and assembly (FTA) operation during assembly of a vehicle, among other types of operations. For example, the end effector 108 of the robot can be used to manipulate a component part (e.g. a car door) of a primary component (e.g. a constituent part of the vehicle, or the vehicle itself as it is being assembled).

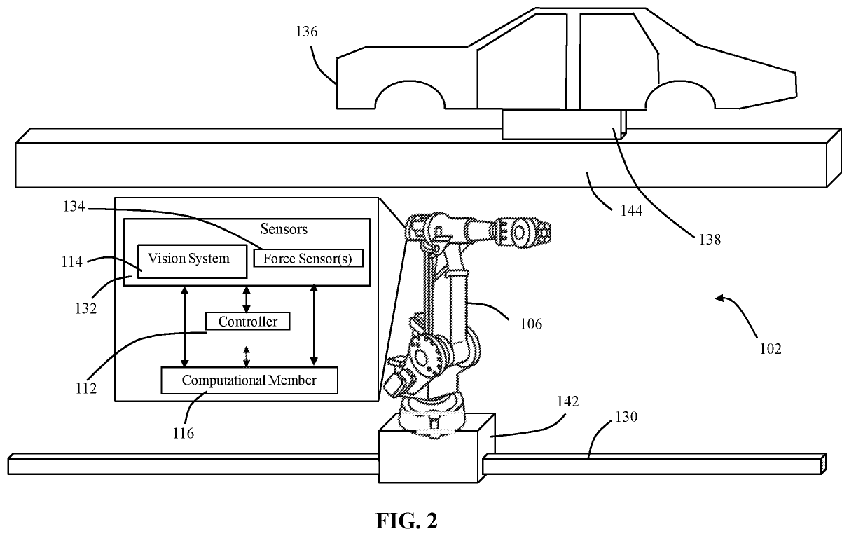

The robot 106 can include, or be electrically coupled to, one or more robotic controllers 112. For example, according to certain embodiments, the robot 106 can include and/or be electrically coupled to one or more controllers 112 that may, or may not, be discrete processing units, such as, for example, a single controller or any number of controllers. The controller 112 can be configured to provide a variety of functions, including, for example, be utilized in the selective delivery of electrical power to the robot 106, control of the movement and/or operations of the robot 106, and/or control the operation of other equipment that is mounted to the robot 106, including, for example, the end effector 108, and/or the operation of equipment not mounted to the robot 106 but which are an integral to the operation of the robot 106 and/or to equipment that is associated with the operation and/or movement of the robot 106. Moreover, according to certain embodiments, the controller 112 can be configured to dynamically control the movement of both the robot 106 itself, as well as the movement of other devices to which the robot 106 is mounted or coupled, including, for example, among other devices, movement of the robot 106 along, or, alternatively, by, a track 130 or mobile platform such as the AGV to which the robot 106 is mounted via a robot base 142, as shown in FIG. 2.

The controller 112 can take a variety of different forms, and can be configured to execute program instructions to perform tasks associated with operating the robot 106, including to operate the robot 106 to perform various functions, such as, for example, but not limited to, the tasks described herein, among other tasks. In one form, the controller(s) 112 is/are microprocessor based and the program instructions are in the form of software stored in one or more memories. Alternatively, one or more of the controllers 112 and the program instructions executed thereby can be in the form of any combination of software, firmware and hardware, including state machines, and can reflect the output of discrete devices and/or integrated circuits, which may be co-located at a particular location or distributed across more than one location, including any digital and/or analog devices configured to achieve the same or similar results as a processor-based controller executing software or firmware based instructions. Operations, instructions, and/or commands (collectively termed ‘instructions’ for ease of reference herein) determined and/or transmitted from the controller 112 can be based on one or more models stored in non-transient computer readable media in a controller 112, other computer, and/or memory that is accessible or in electrical communication with the controller 112. It will be appreciated that any of the aforementioned forms can be described as a ‘circuit’ useful to execute instructions, whether the circuit is an integrated circuit, software, firmware, etc. Such instructions are expressed in the ‘circuits’ to execute actions of which the controller 112 can take (e.g. sending commands, computing values, etc).

According to the illustrated embodiment, the controller 112 includes a data interface that can accept motion commands and provide actual motion data. For example, according to certain embodiments, the controller 112 can be communicatively coupled to a pendant, such as, for example, a teach pendant, that can be used to control at least certain operations of the robot 106 and/or the end effector 108.

In some embodiments the robot station 102 and/or the robot 106 can also include one or more sensors 132. The sensors 132 can include a variety of different types of sensors and/or combinations of different types of sensors, including, but not limited to, a vision system 114, force sensors 134, motion sensors, acceleration sensors, and/or depth sensors, among other types of sensors. It will be appreciated that not all embodiments need include all sensors (e.g. some embodiments may not include motion, force, etc sensors). Further, information provided by at least some of these sensors 132 can be integrated, including, for example, via use of algorithms, such that operations and/or movement, among other tasks, by the robot 106 can at least be guided via sensor fusion. Thus, as shown by at least FIGS. 1 and 2, information provided by the one or more sensors 132, such as, for example, a vision system 114 and force sensors 134, among other sensors 132, can be processed by a controller 120 and/or a computational member 124 of a management system 104 such that the information provided by the different sensors 132 can be combined or integrated in a manner that can reduce the degree of uncertainty in the movement and/or performance of tasks by the robot 106.

According to the illustrated embodiment, the vision system 114 can comprise one or more vision devices 114a that can be used in connection with observing at least portions of the robot station 102, including, but not limited to, observing, parts, component, and/or vehicles, among other devices or components that can be positioned in, or are moving through or by at least a portion of, the robot station 102. For example, according to certain embodiments, the vision system 114 can extract information for a various types of visual features that are positioned or placed in the robot station 102, such, for example, on a vehicle and/or on automated guided vehicle (AGV) that is moving the vehicle through the robot station 102, among other locations, and use such information, among other information, to at least assist in guiding the movement of the robot 106, movement of the robot 106 along a track 130 or mobile platform such as the AGV (FIG. 2) in the robot station 102, and/or movement of an end effector 108. Further, according to certain embodiments, the vision system 114 can be configured to attain and/or provide information regarding at a position, location, and/or orientation of one or more calibration features that can be used to calibrate the sensors 132 of the robot 106.

According to certain embodiments, the vision system 114 can have data processing capabilities that can process data or information obtained from the vision devices 114a that can be communicated to the controller 112. Alternatively, according to certain embodiments, the vision system 114 may not have data processing capabilities. Instead, according to certain embodiments, the vision system 114 can be electrically coupled to a computational member 116 of the robot station 102 that is adapted to process data or information output from the vision system 114. Additionally, according to certain embodiments, the vision system 114 can be operably coupled to a communication network or link 118, such that information outputted by the vision system 114 can be processed by a controller 120 and/or a computational member 124 of a management system 104, as discussed below.

Examples of vision devices 114a of the vision system 114 can include, but are not limited to, one or more imaging capturing devices, such as, for example, one or more two-dimensional, three-dimensional, and/or RGB cameras that can be mounted within the robot station 102, including, for example, mounted generally above or otherwise about the working area of the robot 106, mounted to the robot 106, and/or on the end effector 108 of the robot 106, among other locations. As should therefore be apparent, in some forms the cameras can be fixed in position relative to a moveable robot, but in other forms can be affixed to move with the robot. Some vision systems 114 may only include one vision device 114a. Further, according to certain embodiments, the vision system 114 can be a position based or image based vision system. Additionally, according to certain embodiments, the vision system 114 can utilize kinematic control or dynamic control.

According to the illustrated embodiment, in addition to the vision system 114, the sensors 132 also include one or more force sensors 134. The force sensors 134 can, for example, be configured to sense contact force(s) during the assembly process, such as, for example, a contact force between the robot 106, the end effector 108, and/or a component part being held by the robot 106 with the vehicle 136 and/or other component or structure within the robot station 102. Such information from the force sensor(s) 134 can be combined or integrated with information provided by the vision system 114 in some embodiments such that movement of the robot 106 during assembly of the vehicle 136 is guided at least in part by sensor fusion.

According to the exemplary embodiment depicted in FIG. 1, the management system 104 can include at least one controller 120, a database 122, the computational member 124, and/or one or more input/output (I/O) devices 126. According to certain embodiments, the management system 104 can be configured to provide an operator direct control of the robot 106, as well as to provide at least certain programming or other information to the robot station 102 and/or for the operation of the robot 106. Moreover, the management system 104 can be structured to receive commands or other input information from an operator of the robot station 102 or of the management system 104, including, for example, via commands generated via operation or selective engagement of/with an input/output device 126. Such commands via use of the input/output device 126 can include, but is not limited to, commands provided through the engagement or use of a microphone, keyboard, touch screen, joystick, stylus-type device, and/or a sensing device that can be operated, manipulated, and/or moved by the operator, among other input/output devices. Further, according to certain embodiments, the input/output device 126 can include one or more monitors and/or displays that can provide information to the operator, including, for, example, information relating to commands or instructions provided by the operator of the management system 104, received/transmitted from/to the supplemental database system(s) 105 and/or the robot station 102, and/or notifications generated while the robot 106 is running (or attempting to run) a program or process. For example, according to certain embodiments, the input/output device 126 can display images, whether actual or virtual, as obtained, for example, via use of at least the vision device 114a of the vision system 114. In some forms the management system 104 can permit autonomous operation of the robot 106 while also providing functional features to an operator such as shut down or pause commands, etc.

According to certain embodiments, the management system 104 can include any type of computing device having a controller 120, such as, for example, a laptop, desktop computer, personal computer, programmable logic controller (PLC), or a mobile electronic device, among other computing devices, that includes a memory and a processor sufficient in size and operation to store and manipulate a database 122 and one or more applications for at least communicating with the robot station 102 via the communication network or link 118. In certain embodiments, the management system 104 can include a connecting device that may communicate with the communication network or link 118 and/or robot station 102 via an Ethernet WAN/LAN connection, among other types of connections. In certain other embodiments, the management system 104 can include a web server, or web portal, and can use the communication network or link 118 to communicate with the robot station 102 and/or the supplemental database system(s) 105 via the internet.

The management system 104 can be located at a variety of locations relative to the robot station 102. For example, the management system 104 can be in the same area as the robot station 102, the same room, a neighboring room, same building, same plant location, or, alternatively, at a remote location, relative to the robot station 102. Similarly, the supplemental database system(s) 105, if any, can also be located at a variety of locations relative to the robot station 102 and/or relative to the management system 104. Thus, the communication network or link 118 can be structured, at least in part, based on the physical distances, if any, between the locations of the robot station 102, management system 104, and/or supplemental database system(s) 105. According to the illustrated embodiment, the communication network or link 118 comprises one or more communication links 118 (Comm link_{1-N} in FIG. 1). Additionally, system 100 can be operated to maintain a relatively reliable real-time communication link, via use of the communication network or link 118, between the robot station 102, management system 104, and/or supplemental database system(s) 105. Thus, according to certain embodiments, the system 100 can change parameters of the communication link 118, including, for example, the selection of the utilized communication links 118, based on the currently available data rate and/or transmission time of the communication links 118.

The communication network or link 118 can be structured in a variety of different manners. For example, the communication network or link 118 between the robot station 102, management system 104, and/or supplemental database system(s) 105 can be realized through the use of one or more of a variety of different types of communication technologies, including, but not limited to, via the use of fiber-optic, radio, cable, or wireless based technologies on similar or different types and layers of data protocols. For example, according to certain embodiments, the communication network or link 118 can utilize an Ethernet installation(s) with wireless local area network (WLAN), local area network (LAN), cellular data network, Bluetooth, ZigBee, point-to-point radio systems, laser-optical systems, and/or satellite communication links, among other wireless industrial links or communication protocols.

The database 122 of the management system 104 and/or one or more databases 128 of the supplemental database system(s) 105 can include a variety of information that may be used in the identification of elements within the robot station 102 in which the robot 106 is operating. For example, as discussed below in more detail, one or more of the databases 122, 128 can include or store information that is used in the detection, interpretation, and/or deciphering of images or other information detected by a vision system 114, such as, for example, features used in connection with the calibration of the sensors 132, or features used in connection with tracking objects such as the component parts or other devices in the robot space (e.g. a marker as described below). Additionally, or alternatively, such databases 122, 128 can include information pertaining to the one or more sensors 132, including, for example, information pertaining to forces, or a range of forces, that are to be expected to be detected by via use of the one or more force sensors 134 at one or more different locations in the robot station 102 and/or along the vehicle 136 at least as work is performed by the robot 106. Additionally, information in the databases 122, 128 can also include information used to at least initially calibrate the one or more sensors 132, including, for example, first calibration parameters associated with first calibration features and second calibration parameters that are associated with second calibration features.

The database 122 of the management system 104 and/or one or more databases 128 of the supplemental database system(s) 105 can also include information that can assist in discerning other features within the robot station 102. For example, images that are captured by the one or more vision devices 114a of the vision system 114 can be used in identifying, via use of information from the database 122, FTA components within the robot station 102, including FTA components that are within a picking bin, among other components, that may be used by the robot 106 in performing FTA.

FIG. 2 illustrates a schematic representation of an exemplary robot station 102 through which vehicles 136 are moved by an automated or automatic guided vehicle (AGV) 138, and which includes a robot 106 that is mounted to a robot base 142 that is moveable along, or by, a track 130 or mobile platform such as the AGV. While for at least purposes of illustration, the exemplary robot station 102 depicted in FIG. 2 is shown as having, or being in proximity to, a vehicle 136 and associated AGV 138, the robot station 102 can have a variety of other arrangements and elements, and can be used in a variety of other manufacturing, assembly, and/or automation processes. As depicted, the AGV may travel along a track 144, or may alternatively travel along the floor on wheels or may travel along an assembly route in other known ways. Further, while the depicted robot station 102 can be associated with an initial set-up of a robot 106, the station 102 can also be associated with use of the robot 106 in an assembly and/or production process.

Additionally, while the example depicted in FIG. 2 illustrates a single robot station 102, according to other embodiments, the robot station 102 can include a plurality of robot stations 102, each station 102 having one or more robots 106. The illustrated robot station 102 can also include, or be operated in connection with, one or more AGV 138, supply lines or conveyors, induction conveyors, and/or one or more sorter conveyors. According to the illustrated embodiment, the AGV 138 can be positioned and operated relative to the one or more robot stations 102 so as to transport, for example, vehicles 136 that can receive, or otherwise be assembled with or to include, one or more components of the vehicle(s) 136, including, for example, a door assembly, a cockpit assembly, and a seat assembly, among other types of assemblies and components. Similarly, according to the illustrated embodiment, the track 130 can be positioned and operated relative to the one or more robots 106 so as to facilitate assembly by the robot(s) 106 of components to the vehicle(s) 136 that is/are being moved via the AGV 138. Moreover, the track 130 or mobile platform such as the AGV, robot base 142, and/or robot can be operated such that the robot 106 is moved in a manner that at least generally follows of the movement of the AGV 138, and thus the movement of the vehicle(s) 136 that are on the AGV 138. Further, as previously mentioned, such movement of the robot 106 can also include movement that is guided, at least in part, by information provided by the one or more force sensor(s) 134.

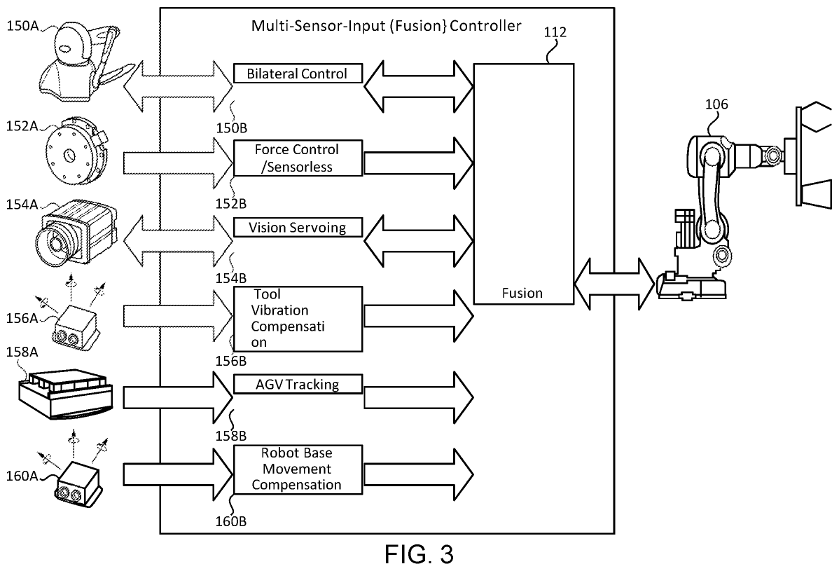

FIG. 3 is an illustration of sensor inputs 150-160 that may be provided to the robot controller 112 in order to control robot 106 movement. For example, the robotic assembly system may be provided with a bilateral control sensor 150A in communication with a bilateral controller 150B. A force sensor 152A (or 134) may also be provided in communication with a force controller 152B. A camera 154A (or 114A) may also be provided in communication with a vision controller 154B (or 114). A vibration sensor 156A may also be provided in communication with a vibration controller 156B. An AGV tracking sensor 158A may also be provided in communication with a tracking controller 158B. A robot base movement sensor 160A may also be provided in communication with a compensation controller 160B. Each of the individual sensor inputs 150-160 communicate with the robot controller 112 and may be fused together to control movement of the robot 106.

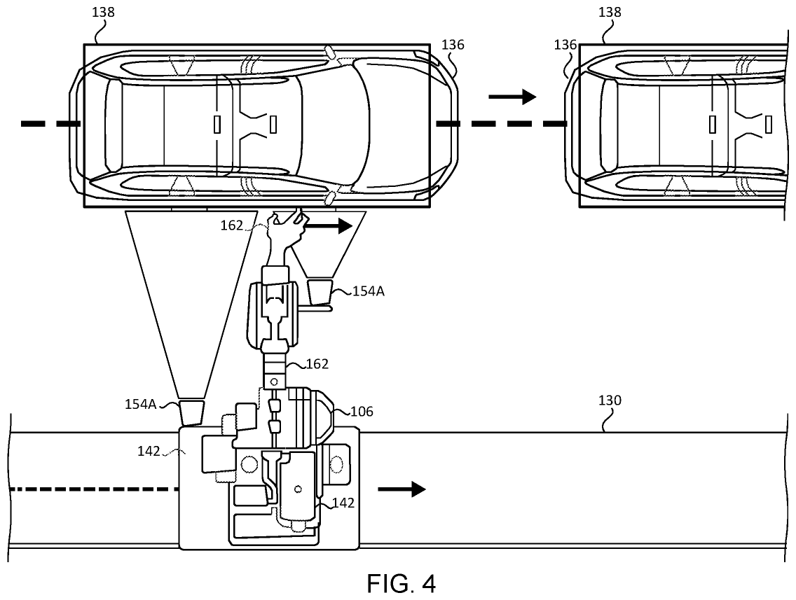

FIG. 4 is another illustration of an embodiment of a robot base 142 with a robot 106 mounted thereon. The robot base 142 may travel along a rail 130 or with wheels along the floor to move along the assembly line defined by the assembly base 138 (or AGV 138). The robot 106 has at least one movable arm 162 that may move relative to the robot base 142, although it is preferable for the robot 106 to have multiple movable arms 162 linked by joints to provide a high degree of movement flexibility.

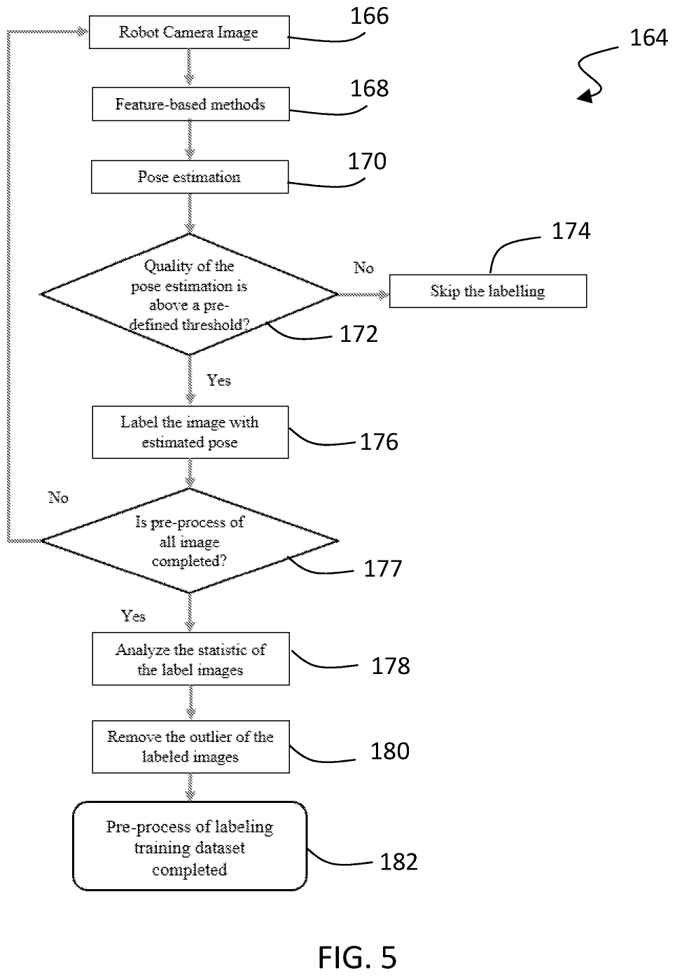

Turning now to FIG. 5, one embodiment of an unsupervised auto-labeling system 164 is depicted which can be used to label training data for a deep learning based moving object tracking system. The embodiment depicted in FIG. 5 uses traditional feature-based/3-dimensional model-based moving object tracking to estimate a pose (e.g. 3-D pose of translation and rotation) and, based on the quality of the pose estimation, label the image collected either online or offline. In many cases the unsupervised auto-labeling system 164 determines the pose of the primary component (e.g. a constituent of the vehicle or the vehicle itself) where knowledge of the component part to be attached to the primary component is well known (e.g. where the component part is attached to the robot, and knowledge of the orientation of the robot is well known). For each of reference, the description that follows may refer to the ‘vehicle’ or ‘vehicle primary component,’ but such references will be understood to include any constituent part of the vehicle as well as the entirety of the vehicle itself, depending on the given application. The unsupervised system 164 can be operated using many of the types of systems and devices of the robotic system 100 described above. For example, the unsupervised system 164 can use a vision system 114 similar to those described above to capture a series of images of the vehicle in various poses. In some cases, the actions of labeling training data for a deep learning based moving object tracking system can be done with the same systems and devices as those used in a production environment. In other words, to take just one example, the vision system 114 used to collect data for the training step can be the same vision system 114 used in a production environment. The same is true of any of the other systems and devices described herein. Reference will be made below to any of the systems and devices recited above for ease of reference, and are not intended to be limiting.

The unsupervised auto-labeling system 164 is structured to capture and/or operate upon a set of images of the vehicle with the vision system 114. One image from the set of images is selected at 166 for labeling. The image can take any variety of forms as noted above and can be converted into any suitable data form and/or format. Feature-based methods are employed at 168 on the image data obtained from 166. It will be appreciated that the feature-based methods can utilize any suitable approach such as edge or corner tracking, etc., on any or all portion of the image. The pose of the vehicle is estimated at 170 by the unsupervised auto-labeling system 164 through a comparison of the features in the image which were extracted at 168 to corresponding portions of a computer based model of the vehicle. The computer based model can take any variety of forms including but not limited to a computer aided design (CAD) numerical model held in database 122. As the features are compared to the computer model a pose is developed which can be defined as three translations relative to a reference origin and three rotations relative to a reference axis system. A confidence measure of the pose can also be determined.

Upon estimating the pose of the vehicle in 170, the unsupervised auto-labeling system 164 is structured to assess the quality of the estimation at 172 and take action based upon the assessment. The quality of estimation includes the metrics, such as the average distance between detected features in image and estimated features based on the object CAD and object pose estimation in 170, and the probability of the object pose estimation based previous keyframe pose estimation. The quality of the pose (e.g. through the confidence measure of 170) can be evaluated and compared against a threshold to determine subsequent action of the unsupervised auto-labeling system 164. The threshold can be specified based on the pose estimation accuracy and robustness requirements in the specific application. The threshold can be a pre-set value which does not change over any number of images, but in some forms can be dynamic. To set for one non-limiting example, the confidence measure of the estimated pose can be compared against a pre-set threshold, and if it is not above the threshold the unsupervised auto-labeling system 164 will progress to 174 and skip the labeling of the image. Though the flow chart does not illustrate, it will be appreciated that if further images exist in the dataset then the process returns to step 168. If the confidence measure satisfies the threshold, then the unsupervised auto-labeling system 164 progresses to 176 and labels the image with the estimated pose. After the image is labeled, the unsupervised auto-labeling system 164 next determines at 177 if further images remain in the image dataset to be labeled. If further images remain the unsupervised auto-labelling system 164 returns to the next camera image at 166.

If all images have been exhausted from the set of images as determined at 177, the unsupervised auto-labelling system 164 proceeds to analyze the labeled images as a group to produce one or more statistical measures of the images at 178. For example, analyze the smoothness of the object movement based on the object pose labeled in a group of images. The change of object pose in translation and rotation between adjacent labeled images should be within a threshold. The threshold can be specified based on the speed and acceleration of robot movement in the specific application. The image/pose pairs are each individually compared against the statistical measures and those particular image/pose pairs that fall outside an outlier threshold are removed from the image/pose dataset at 180. After the final cleaning in 180 the unsupervised auto-labelling system 164 is considered complete at 182.

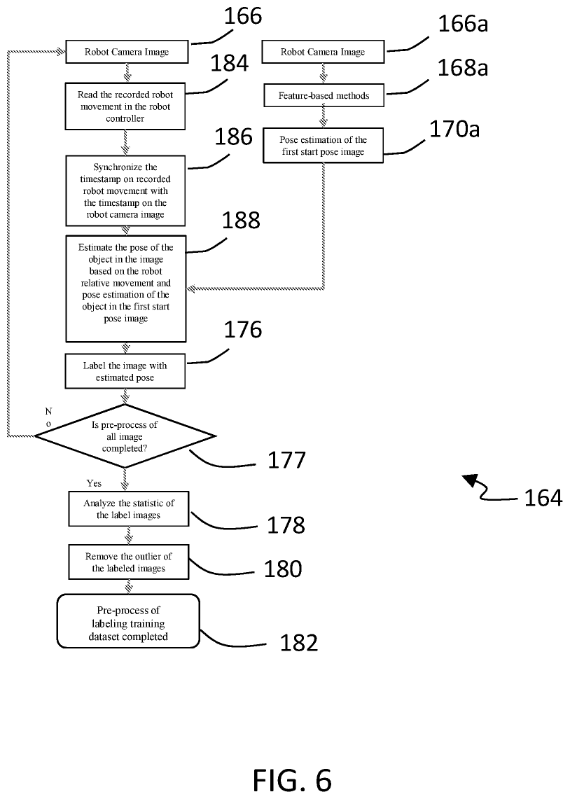

FIG. 6 depicts another embodiment of the unsupervised auto-labelling system 164. The embodiment depicted in FIG. 6 includes an embodiment in which a camera of the vision system 114 is mounted to the robot arm. Based on information related to the robot movement recorded in the robot controller (e.g. controller 120), the system 164 estimates the change in camera relative pose to the vehicle. In this embodiment, traditional feature-based/3-D model-based moving object tracking is used to estimate the 3D pose of the first, or ‘initial’, pose of the vehicle. After the initial pose estimation, the auto-labeling system 164 will automatically label the rest of the images based upon movement of the robot.

As above, the unsupervised auto-labeling system 164 is structured to capture and/or operate upon a set of images of the vehicle with the vision system 114. In the embodiment depicted in FIG. 6, the set of images are collected as is the movement of the robot arm. One image from the set of images is selected at 166 for labeling. The image can take any variety of forms as noted above and can be converted into any suitable data form and/or format.

Also, at step 166a an image from the set of images is selected as the ‘initial’ image. Feature-based methods are employed at 168a on the image data obtained from 166a. It will be appreciated that the feature-based methods can utilize any suitable approach such as edge or corner tracking, etc., on any or all portion of the image. The pose of the vehicle is estimated at 170a by the unsupervised auto-labeling system 164 through a comparison of the features in the image which were extracted at 168a to corresponding portions of a computer based model of the vehicle. The computer based model can take any variety of forms including but not limited to a computer aided design (CAD) numerical model held in database 122. As the features are compared to the computer model a pose is developed which can be defined as three translations relative to a reference origin and three rotations relative to a reference axis system. A confidence measure of the pose can also be determined. The ‘initial’ pose is paired with information regarding state of the robot arm (position, orientation, etc) so that subsequent images can be labeled based on the ‘initial’ pose and subsequent movement of the robot arm.

Though the flow chart does not explicitly state, the process of evaluating the ‘initial’ image can also determine whether the ‘initial’ pose has sufficient quality, and in that regard upon estimating the pose of the vehicle in 170, the unsupervised auto-labeling system 164 can further be structured to assess the quality of the ‘initial’ pose estimation and take action based upon the assessment. The quality of the ‘initial’ pose estimation can include metrics such as the average distance between detected features in image and estimated features based on the object CAD and object pose estimation in 170, and the probability of the object pose estimation based previous keyframe pose estimation. The quality of the ‘initial’ pose (e.g. through the confidence measure of 170a) can be evaluated and compared against a threshold to determine subsequent action of the unsupervised auto-labeling system 164. The threshold can be specified based on the pose estimation accuracy and robustness requirements in the specific application. The threshold can be a pre-set value which does not change over any number of images, but in some forms can be dynamic. To set for one non-limiting example, the confidence measure of the estimated ‘initial’ pose can be compared against a pre-set threshold, and if it is not above the threshold the unsupervised auto-labeling system 164 can return to step 166a to select another image in the search for an image/pose pair that will satisfy a quality measure and serve as the baseline image/pose pair for subsequent action by the unsupervised auto-labeling system 164.

After step 166 the unsupervised auto-labeling system 164 reads the recorded robot movement associated with the image selected in 166. The timestamp on recorded robot movement that is read in 184, is generated by a computer clock in a robot controller. The timestamp on the robot camera image that is read in 166, is generated by a computer clock in a camera or a vision computer, which acquired the image from the camera. These two timestamps can be generated in different rate and by different computer clocks. In such situations they need to be then synchronized in 186. Different methods can be used to synchronized two timestamps. For examples, 1) robot movement data also recorded when the camera is trigged by hardwired robot controller output to acquire the robot camera image; 2) robot controller clock and camera/vision computer clock is synchronized by a precision time protocol throughout a computer network; 3) analyze the robot movement data to find a timestamp when the robot starts to move from initial pose. An analysis can then be performed to with respect to the camera image to find when the image starts to change from initial pose. For examples, calculate the mean squared error (MSE) of the grayscale value of each pixel between two adjacent timestamp camera images. Then compare it with a pre-set threshold, that is determined by the noise-level of camera image. If the MSE is above the threshold, the ‘initial’ pose camera image is identified, Then the timestamp of the ‘initial’ pose camera image matches the timestamp of the ‘initial’ robot pose change in robot movement data. Another example is to first use feature-based method to estimate the object pose of each camera image. Then analyze the data correlation between estimated object pose of camera images over camera images timestamp and the robot poses recorded in robot movement data over timestamp in robot movement data. By maximizing this correlation value over the delay between two timestamps, the two timestamps are synchronized. The auto-labeling system 164 then attempts to estimate the pose of the current image based upon the ‘initial’ pose and the relative movement of the robot as between the initial position and orientation and the position and orientation associated with the image of which the pose is to be determined. Once determined, the image is labeled with the estimated pose.

Just as with the estimation of the ‘initial’ pose, a confidence measure of the pose can also be determined in some embodiments. The unsupervised auto-labeling system 164 can therefore also be structured to assess the quality of the estimation at 172 and take action based upon the assessment. The quality of the ‘initial’ pose estimation includes metrics such as the average distance between detected features in image and estimated features based on the object CAD and object pose estimation in 170, and the probability of the object pose estimation based previous keyframe pose estimation. The quality of the pose (e.g. through the confidence measure discussed immediately above) can be evaluated and compared against a threshold to determine subsequent action of the unsupervised auto-labeling system 164. The threshold can be specified based on the pose estimation accuracy and robustness requirements in the specific application. The threshold can be a pre-set value which does not change over any number of images, but in some forms can be dynamic. To set for one non-limiting example, the confidence measure of the estimated pose can be compared against a pre-set threshold, and if it is not above the threshold the unsupervised auto-labeling system 164 may be structured to skip the labeling of the image.

After the image is labeled in 176, the unsupervised auto-labeling system 164 next determines at 177 if further images remain in the image dataset to be labeled. If further images remain the unsupervised auto-labelling system 164 returns to the next camera image at 166.

If all images have been exhausted from the set of images as determined at 177, the unsupervised auto-labelling system 164 proceeds to analyze the labeled images as a group to produce one or more statistical measures of the images at 178. For example, analyze the smoothness of the object movement based on the object pose labeled in a group of images. The change of object pose in translation and rotation between adjacent labeled images should be within a threshold. The threshold can be specified based on the speed and acceleration of robot movement in the specific application. The image/pose pairs are each individually compared against the statistical measures and those particular image/pose pairs that fall outside an outlier threshold are removed from the image/pose dataset at 180. After the final cleaning in 180 the unsupervised auto-labelling system 164 is considered complete at 182.

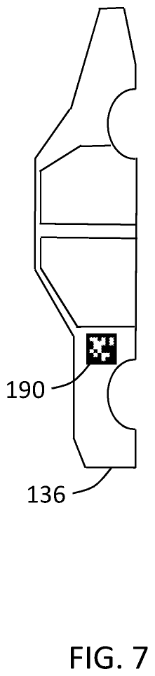

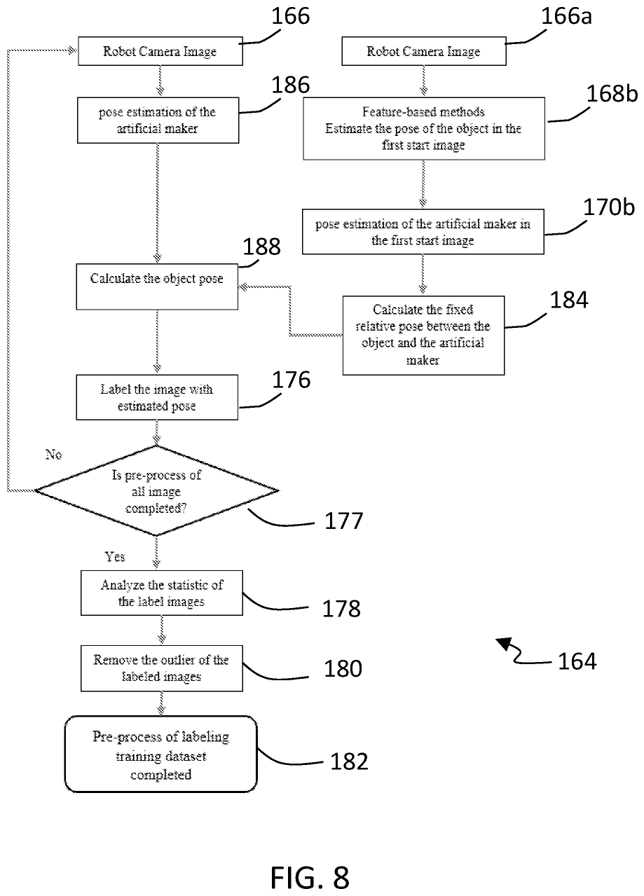

FIGS. 7 and 8 depict another embodiment of the unsupervised auto-labelling system 164. The embodiment depicted in FIGS. 7 and 8 utilize a temporary artificial marker (see artificial marker 190 in FIG. 7) placed in a fixed location relative to the vehicle. In some forms the artificial marker is positioned to travel with the vehicle as described above with respect to the AGV. Based on a pose estimation of the artificial marker 190 and the pose estimation of the relative pose between the vehicle and the artificial marker, the images collected from the vision system 114 can be automatically labeled. As will be appreciated by the discussion below, after the initial pose estimation, the auto-labeling system 164 will automatically label the rest of the images based upon movement of the robot.

As above, the unsupervised auto-labeling system 164 is structured to capture and/or operate upon a set of images of the vehicle with the vision system 114. In the embodiment depicted in FIG. 8, the set of images, images from the set of images are individually selected for processing. The images used herein can take any variety of forms as noted above and can be converted into any suitable data form and/or format.

Also, at step 166a an image from the set of images is selected as the ‘initial’ image. Feature-based methods are employed at 168b on the image data obtained from 166a to obtain the pose of the vehicle in the first image through a comparison of the features in the image which were extracted at 168b to corresponding portions of a computer based model of the vehicle. It will be appreciated that the feature-based methods can utilize any suitable approach such as edge or corner tracking, etc., on any or all portion of the image. The pose of the artificial marker 182 is also estimated at 170b by the unsupervised auto-labeling system 164 through a comparison of the features in the image which were extracted at 168a to corresponding portions of a computer based model of the artificial marker 182. The computer based model of the vehicle and/or artificial marker 182 can take any variety of forms including but not limited to a computer aided design (CAD) numerical model held in database 122. As the features in steps 168a and 170b are compared to respective computer models a pose is developed which can be defined as three translations relative to a reference origin and three rotations relative to a reference axis system. A confidence measure of either or each of the poses from 168b and 170b can also be determined. In step 184 the unsupervised auto-labeling system 164 calculates the fixed relative pose between the pose determined in step 168a and the pose determined in step 170b between the vehicle and the artificial marker 182.

Though the flow chart does not explicitly state, the process of evaluating the ‘initial’ image can also determine whether the ‘initial’ pose of the vehicle and/or artificial marker has sufficient quality, and in that regard upon estimating those respective poses, the unsupervised auto-labeling system 164 can further be structured to assess the quality of the ‘initial’ pose estimations and take action based upon the assessment. The quality of the ‘initial’ pose estimation includes metrics such as the average distance between detected features in image and estimated features based on the object CAD and object pose estimation in 170, and the probability of the object pose estimation based previous keyframe pose estimation. The quality of the ‘initial’ poses (e.g. through the confidence measures described above) can be evaluated and compared against a threshold to determine subsequent action of the unsupervised auto-labeling system 164. The threshold can be specified based on the pose estimation accuracy and robustness requirements in the specific application. The threshold can be a pre-set value which does not change over any number of images, but in some forms can be dynamic. To set for one non-limiting example, the confidence measure of the estimated ‘initial’ poses can be compared against a pre-set threshold, and if it is not above the threshold the unsupervised auto-labeling system 164 can return to step 166a to select another image in the search for an image/pose pair of the vehicle and/or artificial marker that will satisfy a quality measure and serve as the baseline image/pose pairs for subsequent action by the unsupervised auto-labeling system 164.

After step 166 the unsupervised auto-labeling system 164 cycles through other images from the dataset and estimates the pose of the artificial marker in each of those other images at step 186. Just as with the estimation of the ‘initial’ pose, a confidence measure of the pose in step 186 can also be determined in some embodiments. The unsupervised auto-labeling system 164 can therefore also be structured to assess the quality of the estimation at 186 and take action based upon the assessment. The quality of the ‘initial’ pose estimation includes metrics such as the average distance between detected features in image and estimated features based on the object CAD and object pose estimation in 170, and the probability of the object pose estimation based previous keyframe pose estimation. The quality of the pose (e.g. through a confidence measure associated with the pose estimate at 186) can be evaluated and compared against a threshold to determine subsequent action of the unsupervised auto-labeling system 164. The threshold can be specified based on the pose estimation accuracy and robustness requirements in the specific application. The threshold can be a pre-set value which does not change over any number of images, but in some forms can be dynamic. To set for one non-limiting example, the confidence measure of the estimated pose can be compared against a pre-set threshold, and if it is not above the threshold the unsupervised auto-labeling system 164 may be structured to skip the labeling of the image and process to the next image in the dataset.

At step 188 the unsupervised auto-labeling system 164 calculates the vehicle pose by comparing the pose of the artificial marker estimated at 186 with the fixed relative pose between the vehicle and the artificial marker 182 estimated at 184. The image is subsequently labeled at 176 based upon the analysis in 188.

After the image is labeled in 176, the unsupervised auto-labeling system 164 next determines at 177 if further images remain in the image dataset to be labeled. If further images remain the unsupervised auto-labelling system 164 returns to the next camera image at 166.

If all images have been exhausted from the set of images as determined at 177, the unsupervised auto-labelling system 164 proceeds to analyze the labeled images as a group to produce one or more statistical measures of the images at 178. For example, analyze the smoothness of the object movement based on the object pose labeled in a group of images. The change of object pose in translation and rotation between adjacent labeled images should be within a threshold. The threshold can be specified based on the speed and acceleration of robot movement in specific applications. The image/pose pairs are each individually compared against the statistical measures and those particular image/pose pairs that fall outside an outlier threshold are removed from the image/pose dataset at 180. After the final cleaning in 180 the unsupervised auto-labelling system 164 is considered complete at 182.

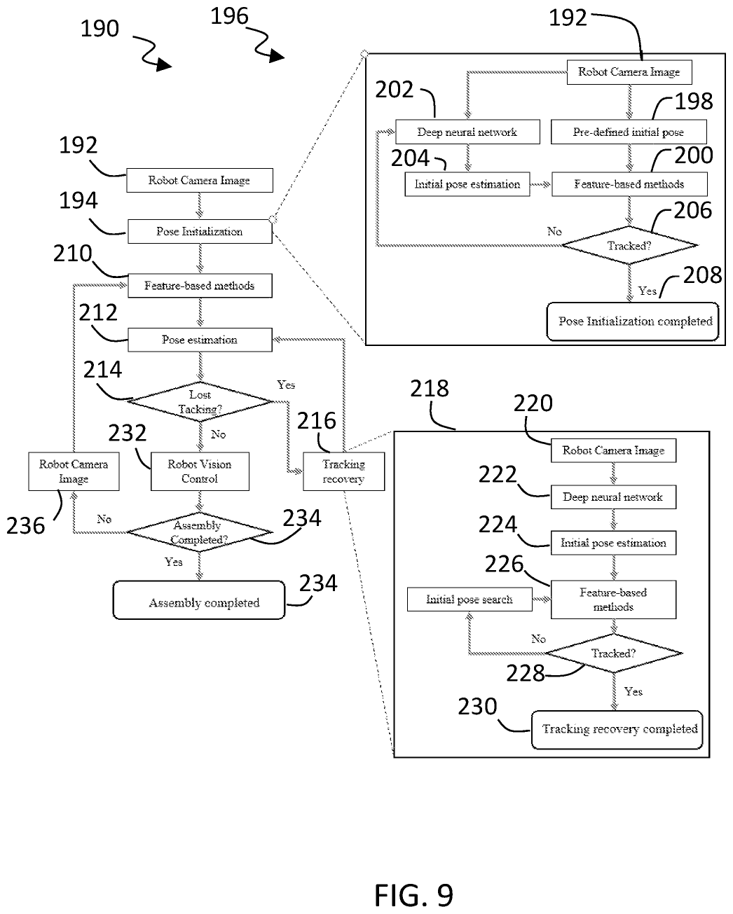

FIG. 9 depicts an embodiment of a runtime system 190 which uses a neural network (e.g. a deep learning network which uses multiple hidden layers) to augment feature based object tracking of the vehicle. The runtime system 190 is initialized using an image of the vehicle at 192 as well as a pose initialization at step 194 which uses the vehicle image from 192 and an augmented subsystem at 196. Similar to the embodiments described above with respect to the auto-labeling system 164, an image is taken of the vehicle at 192.

An initial pose is pre-defined at step 198, from which follows feature based methods at 200 useful to estimate the pose of the vehicle in the ‘initial’ image. Step 198 proceeds by a comparison of the features in the image which were extracted to corresponding portions of a computer based model of the vehicle. It will be appreciated that the feature-based methods can utilize any suitable approach such as edge or corner tracking, etc., on any or all portion of the image. The computer based model of the vehicle can take any variety of forms including but not limited to a computer aided design (CAD) numerical model held in database 122. As the features are compared to respective computer models a pose is developed which can be defined as three translations relative to a reference origin and three rotations relative to a reference axis system. A confidence measure of the pose determined at 200 can also be determined.

Though the flow chart does not explicitly state, the process of evaluating the ‘initial’ image can also determine whether the ‘initial’ pose of the vehicle has sufficient quality, and in that regard upon estimating the pose, the system 190 can further be structured to assess the quality of the ‘initial’ pose estimation and take action based upon the assessment. The quality of the ‘initial’ pose estimation includes metrics such as the average distance between detected features in image and estimated features based on the object CAD and object pose estimation in 170, and the probability of the object pose estimation based previous keyframe pose estimation. The quality of the ‘initial’ pose (e.g. through the confidence measure described above) can be evaluated and compared against a threshold to determine subsequent action of the system 190. The threshold can be specified based on the pose estimation accuracy and robustness requirements in the specific applications. The threshold can be a pre-set value which does not change over any number of images, but in some forms can be dynamic. To set for one non-limiting example, the confidence measure of the estimated ‘initial’ pose can be compared against a pre-set threshold, and if it is not above the threshold the system 190 can return to step 182 to select another image in the search for an image/pose pair of the vehicle that will satisfy a quality measure and serve as the baseline image/pose pair for subsequent action by the system 190.

Operating in conjunction with the feature based methods, a neural network (e.g. a deep learning neural network) can be employed to augment and improve the robustness of the feature based methods described above. The discussion below may refer to a ‘deep learning network’ or ‘deep learning model’ as a matter of descriptive convenience, but no limitation is intended regarding the type of neural network used in step 202 or elsewhere throughout this disclosure. Step 202 depicts the process of employing a deep learning model trained on data to provide an initial deep learning derived estimate of the pose at step 204. Similar to the confidence measure described above with respect to the feature based object tracking, a confidence measure can be provided and appropriate action taken with respect to whether the confidence measure of the deep learning estimated pose is sufficient to proceed further or select another ‘initial’ image.

The output of the pose estimated by the deep learning model is compared to the output of the pose estimated by the by the feature based model (not shown on the figure). Step 206 determines if the poses provided by both methods are of a sufficient measure, and if so one or the other pose estimate (or an average or blended pose estimate) is declared as the ‘initialized’ pose at step 208. If not, the augmented subsystem 196 can return to the deep learning at 202 and, depending on embodiments, may select another image to restart process 192 and subsequent deep learning 202 and feature based method 200.

Once the augmented subsystem 196 completes feature based methods at 210 are subsequently employed on all subsequent images used in the runtime system 190. The same techniques described above with respect to feature based object tracking in the other embodiments of the instant disclosure are also applicable here. The feature based object tracking provides a pose estimation at 212 and, if tracking is lost at 214 then a tracking recovery is initiated at 216. When tracking recovery is initiated a deep learning recovery module 218 is executed which includes using a current robot camera image at 220 and processing it through the deep learning model at 222 which is able to provide an initial pose estimate at 224 as a result of the tracking recovery being initiated. In some forms the robot camera image used in the deep learning recovery module 218 can be the same image used at the last track point, it can be the image used when tracking was lost, or it can be a refreshed image once tracking is lost. Feature based methods can be used at 226 and, if the feature based pose estimated at 226 tracks in step 228 with the pose estimated from 222 and 224 then tracking recovery is declared complete at 230 and runtime is returned to 212 (in some forms the recovered pose is provide to robot vision control 232). As will be appreciated, the quality of pose estimations at 222 and 224 as well as 226 can be evaluated and acted upon as in any of the embodiments above. If the poses do not track at 228 then an initial pose search is initiated which in some embodiments takes the form of module 196 described above.

If tracking is not lost at 214 then the runtime system 190 progresses to robot vision control 234 to continue its runtime operation. If assembly is not complete at 234 then another image is obtained at 236 to being the process of pose estimation using feature-based object tracking and deep learning model augmented pose estimation. Assembly is declared complete at 238.

One aspect of the present application includes an apparatus comprising an unsupervised auto-labeling system structured to provide a label to an image indicative of a pose of the object, the unsupervised auto-labeling system having: a computer based model of a vehicle primary component to which a component part is to be coupled with by a robot connected with the vehicle primary part; a vision system camera structured to obtain an image of the vehicle primary component; and an instruction circuit structured to compare the image of the vehicle primary component to the computer based model of the vehicle primary component and label the image with a pose of the vehicle primary component, the pose including a translation and rotation of the part in a workspace.

A feature of the present application includes wherein the vision system camera is a two-dimensional (2-D) camera structured to capture a two-dimensional image of the vehicle primary component.

Another feature of the present application includes wherein the computer based model is a computer aided design (CAD) model of the vehicle primary component.

Yet another feature of the present application includes wherein the unsupervised auto-labeling system structured to cycle through a plurality of images of the vehicle primary component to generate a plurality of poses of the vehicle primary component corresponding to respective images of the plurality of images, the unsupervised auto-labeling system further structured determine a statistical assessment of the plurality of poses and remove outliers based upon a threshold.

Still another feature of the present application includes wherein the instruction circuit is further structured to label the image with a pose only if a comparison between the image of the vehicle primary component to the computer based model of the vehicle primary component satisfies a pre-defined quality threshold.

Yet still another feature of the present application includes wherein the image is an initial image at a start of a robot operation, the pose is an initial pose at the start of the robot operation, wherein the unsupervised auto-labeling system is structured to record a robot initial position corresponding to the initial pose, and wherein the unsupervised auto-labeling system is structured to estimate subsequent poses of the vehicle primary component after the initial pose based upon movement of the robot relative to the robot initial position as well as the initial pose.

Still yet another feature of the present application includes wherein the initial pose and the subsequent poses form a set of vehicle primary component poses, and wherein the unsupervised auto-labeling system is further structured to determine a statistical assessment of the set of vehicle primary component poses and remove outliers of the set of vehicle primary component poses based upon a threshold.

A further feature of the present application includes wherein the image is an initial image at a start of a robot operation, the pose is an initial pose at the start of the robot operation, wherein the unsupervised auto-labeling system is further structured to: determine a pose of an artificial marker apart from the vehicle primary component in the initial image; and determine a relative pose between the vehicle primary component and the artificial marker.

A still further feature of the present application includes wherein a plurality of images are labeled with the unsupervised auto-labeling system, where a set of images from the plurality of images except the initial image are evaluated to determine a pose of each image of the set of images, the unsupervised auto-labeling system determining the pose of each image of the set of images using a pose estimation of the artificial marker associated with each of the set of images and the relative pose between the vehicle primary component and the artificial marker used to determine

A yet further feature of the present application includes wherein the initial pose and the pose of each image of the set of images form a set of vehicle primary component poses, and wherein the unsupervised auto-labeling system is further structured to determine a statistical assessment of the set of vehicle primary component poses and remove outliers of the set of vehicle primary component poses based upon a threshold.

Another aspect of the present application includes an apparatus comprising a robot pose estimation system having a set of instructions configured to determine a pose of a vehicle primary component during a run-time installation of the vehicle primary component to a primary part, the robot pose estimation system including instructions to: determine an initial pose estimate using feature based object tracking by comparing an image of the vehicle primary component taken by a vision system camera against a computer based model of the vehicle primary component; and determine a neural network pose estimate using a neural network model trained to identify a pose of the vehicle primary component from the image.

A feature of the present application includes wherein the computer based model is a computer aided design (CAD) model.

Another feature of the present application includes wherein the neural network model is a multi-layered artificial neural network.

Yet another feature of the present application includes wherein the robot pose estimation system also including instructions to compare the initial pose estimate with the neutral network pose estimate.

Still another feature of the present application includes wherein the robot pose estimation system also including instructions to initialize a pose estimate based upon a comparison between the initial pose estimate from the feature based object tracking with the neural network pose estimate, the robot pose estimation system also including instructions to: track pose during run-time with the feature based object tracking; determine if tracking is lost by the feature based object tracking during run-time; and engage a tracking recovery mode in which the neural network model is used on a tracking recovery mode image provided to the tracking recovery mode to reacquire the pose estimation.

Yet another feature of the present application includes wherein in the tracking recovery mode a neural network pose estimate is obtained from the tracking recovery mode image and compared against a feature based pose estimate from the tracking recovery mode image.

Still yet another feature of the present application includes wherein the robot pose estimation system is structured to initialize a pose estimate when a comparison of the initial pose estimate with the neutral network pose estimate satisfies an initialization threshold.

Yet still another feature of the present application includes wherein the robot pose estimation system is structured to engage a tracking recovery mode when the feature based object tracking during run-time fails to satisfy a tracking threshold.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

What is claimed is:

1. An apparatus comprising:
an unsupervised auto-labeling system structured to provide a label to an image indicative of a pose of the object, the unsupervised auto-labeling system having:
a computer based model of a vehicle primary component to which a component part is to be coupled with by a robot connected with the vehicle primary part;
a vision system camera structured to obtain an image of the vehicle primary component; and
an instruction circuit structured to compare the image of the vehicle primary component to the computer based model of the vehicle primary component and label the image with a pose of the vehicle primary component, the pose including a translation and rotation of the part in a workspace.

2. The apparatus of claim 1, wherein the vision system camera is a two-dimensional (2-D) camera structured to capture a two-dimensional image of the vehicle primary component.

3. The apparatus of claim 1, wherein the computer based model is a computer aided design (CAD) model of the vehicle primary component.

4. The apparatus of claim 1, wherein the unsupervised auto-labeling system structured to cycle through a plurality of images of the vehicle primary component to generate a plurality of poses of the vehicle primary component corresponding to respective images of the plurality of images, the unsupervised auto-labeling system further structured determine a statistical assessment of the plurality of poses and remove outliers based upon a threshold.

5. The apparatus of claim 4, wherein the instruction circuit is further structured to label the image with a pose only if a comparison between the image of the vehicle primary component to the computer based model of the vehicle primary component satisfies a pre-defined quality threshold.

6. The apparatus of claim 1, wherein the image is an initial image at a start of a robot operation, the pose is an initial pose at the start of the robot operation, wherein the unsupervised auto-labeling system is structured to record a robot initial position corresponding to the initial pose, and wherein the unsupervised auto-labeling system is structured to estimate subsequent poses of the vehicle primary component after the initial pose based upon movement of the robot relative to the robot initial position as well as the initial pose.

7. The apparatus of claim 6, wherein the initial pose and the subsequent poses form a set of vehicle primary component poses, and wherein the unsupervised auto-labeling system is further structured to determine a statistical assessment of the set of vehicle primary component poses and remove outliers of the set of vehicle primary component poses based upon a threshold.

8. The apparatus of claim 1, wherein the image is an initial image at a start of a robot operation, the pose is an initial pose at the start of the robot operation, wherein the unsupervised auto-labeling system is further structured to:
determine a pose of an artificial marker apart from the vehicle primary component in the initial image; and
determine a relative pose between the vehicle primary component and the artificial marker.

9. The apparatus of claim 8, wherein a plurality of images are labeled with the unsupervised auto-labeling system, where a set of images from the plurality of images except the initial image are evaluated to determine a pose of each image of the set of images, the unsupervised auto-labeling system determining the pose of each image of the set of images using a pose estimation of the artificial marker associated with each of the set of images and the relative pose between the vehicle primary component and the artificial marker used to determine

10. The apparatus of claim 9, wherein the initial pose and the pose of each image of the set of images form a set of vehicle primary component poses, and wherein the unsupervised auto-labeling system is further structured to determine a statistical assessment of the set of vehicle primary component poses and remove outliers of the set of vehicle primary component poses based upon a threshold.

11. An apparatus comprising:
a robot pose estimation system having a set of instructions configured to determine a pose of a vehicle primary component during a run-time installation of the vehicle primary component to a primary part, the robot pose estimation system including instructions to:
determine an initial pose estimate using feature based object tracking by comparing an image of the vehicle primary component taken by a vision system camera against a computer based model of the vehicle primary component; and
determine a neural network pose estimate using a neural network model trained to identify a pose of the vehicle primary component from the image.

12. The apparatus of claim 11, wherein the computer based model is a computer aided design (CAD) model.

13. The apparatus of claim 11, wherein the neural network model is a multi-layered artificial neural network.

14. The apparatus of claim 11, wherein the robot pose estimation system also including instructions to compare the initial pose estimate with the neutral network pose estimate.

15. The apparatus of claim 14, wherein the robot pose estimation system also including instructions to initialize a pose estimate based upon a comparison between the initial pose estimate from the feature based object tracking with the neural network pose estimate, the robot pose estimation system also including instructions to:
track pose during run-time with the feature based object tracking;
determine if tracking is lost by the feature based object tracking during run-time; and
engage a tracking recovery mode in which the neural network model is used on a tracking recovery mode image provided to the tracking recovery mode to reacquire the pose estimation.

16. The apparatus of claim 15, wherein in the tracking recovery mode a neural network pose estimate is obtained from the tracking recovery mode image and compared against a feature based pose estimate from the tracking recovery mode image.

17. The apparatus of claim 15, wherein the robot pose estimation system is structured to initialize a pose estimate when a comparison of the initial pose estimate with the neutral network pose estimate satisfies an initialization threshold.

18. The apparatus of claim 15, wherein the robot pose estimation system is structured to engage a tracking recovery mode when the feature based object tracking during run-time fails to satisfy a tracking threshold.
